(19) United States
(12) Patent Application Publication
(10) Pub. No.: US 2011/0256934 A1
(43) Pub. Date: Oct. 20, 2011

(54) System and Method of Using Existing Cabling While Achieving Ethernet Network Capabilities and Speed

(75) Inventors: Paul McLaughlin, Brigantine, NJ (US); Wayne Walkwitz, Waterford Works, NJ (US)

(73) Assignee: MicroFirst

(21) Appl. No.: 13/087,028

(22) Filed: Apr. 14, 2011

Related U.S. Application Data
(60) Provisional application No. 61/324,154, filed on Apr. 14, 2010.

(51) Int. Cl. A63F 9/24

(52) U.S. Cl. 463/42

(57) ABSTRACT

A communication network and method of conversion provides an Ethernet and a first protocol to a gaming area. The network includes a server area Ethernet; a gaming area Ethernet; a long cable; a first converter connected to an end of the long cable and arranged to communicate with a second converter using a first protocol over the long cable, and connected to the server area Ethernet; the second converter connected to the long cable and arranged to communicate with the first converter using the first protocol, and connected to the gaming area Ethernet; a controller board of a gaming device located in the gaming area, communicating via the first and second converter using a second protocol with a game controller computer located in the server area Ethernet; and a game board of the gaming device, and communicating via the first and second converter using Ethernet with a server.

### CROSS-REFERENCE TO RELATED PATENT APPLICATION

This application claims the benefit of Provisional Patent Application No. 61/324154, filed on Apr. 14, 2010, in the United States Patent and Trademark Office, the entire disclosure of which is incorporated herein by reference.

### BACKGROUND

1. Field

The disclosure relates to a method of upgrading a communications network in a gaming establishment, and the upgraded communication network, and more particularly to a method of upgrading a communication network where existing wires are utilized to both accommodate existing data communication and provide new high speed data.

2. Description of the Related Art

Gaming establishments such as casinos are physically large, and often have communication networks that were designed and installed many years ago. Often gaming establishments have hundreds or thousands of gaming devices such as slot machines. The slot machines include a slot system controller board installed that keeps track of the money the slot machine has received. The slot system controller board is normally regulated by government gaming boards that determine taxes due from the casinos based on data gathered from the slot system controller boards. The data from the slot system controller board needs to be secure, and the communication networks are often regulated by the government gaming boards to insure that the data is secure. The wiring to the slot machines is often spread throughout a very large physical area with the wires strung up and down columns and attached to ceilings to make their way to a slot machine.

Since those communication networks were installed, technology has advanced with both the communications networks and the gaming devices. Communication networks have become much faster and gaming devices have developed applications that require high speed data to run properly. Additionally, there may be applications that the gaming establishment would like to provide near the gaming devices. For example, the gaming establishment may want to provide advertisements and/or Internet access for guests near the gaming devices. Therefore, there is a need for delivery of high speed data to the gaming devices so that more applications can be run on the slot machines. Moreover, there is a need for high speed data near slot machines to provide such devices as computers to display announcements and advertisements to the customers of the slot machines.

### SUMMARY

A communication network for providing an Ethernet network and a first protocol to a plurality of gaming devices in a gaming area of a gaming establishment is disclosed herein. The network including a server area Ethernet located in a server area of the gaming establishment; a gaming area Ethernet located in the gaming area of the gaming establishment; a long cable comprising at least a first twisted pair of wires and having a first end located in the server area of the gaming establishment and a second end located in the gaming area of the gaming establishment; a first converter connected to the first end of the long cable and arranged to communicate with a second converter using a first protocol over the first twisted pair of wires, and connected to the server area Ethernet, and arranged to convert between the first protocol over the long cable and the server end Ethernet; the second converter connected to the second end of the long cable and arranged to communicate with the first converter using the first protocol over the first twisted pair of wires, and connected to the gaming area Ethernet, and arranged to convert between the first protocol over the long cable and the gaming area Ethernet; a controller board of a gaming device located in the gaming area, and arranged to communicate via the first and second converter using a second protocol with a game controller computer located in the server area Ethernet; and a game board of the gaming device located in the gaming area, and arranged to communicate via the first and second converter using Ethernet with a server.

The gaming devices may be slot machines.

The gaming establishment may be a casino.

The long cable may be a cable that is at least 1000 feet long.

The long cable may be longer than a rated communications distance between two Ethernet network devices.

The communication network may include a third converter arranged to communicate with the controller board using the second protocol and to communicate with the gaming area Ethernet using Ethernet, and arranged to convert between the second protocol and Ethernet.

The communication network may include an Ethernet device arranged between the second converter and the gaming area Ethernet, wherein the controller board communicates with the game controller computer via the Ethernet device, and wherein the game board communicates with the server via the Ethernet device.

The Ethernet device may be arranged so that the game board does not receive Ethernet packets sent by the controller board.

The Ethernet device may be an Ethernet switch.

The communication network may include an Ethernet access point located in the gaming area, and arranged to communicate via the first and second converter using Ethernet with a server, wherein the Ethernet access point provides at least one of: a user access to Ethernet for user devices or an access point for casino related devices that are not slot machines.

The communication network may include a fourth converter arranged to communicate with the game controller computer using the second protocol and to communicate with the server area Ethernet using Ethernet, and arranged to convert between the second protocol and Ethernet.

The game board may be arranged to communicate via the first and second converter using Ethernet with an Internet.

The second protocol may be at least one of: RS-485 and Ethernet.

The first protocol may be a digital subscriber line.

The long cable further may include a second twisted pair of wires, and the communication network may include a fifth and sixth converter arranged to communicate over the second twisted pair of wires, and the communication network may include an Ethernet access point located in the gaming area, and arranged to communicate via the fifth and sixth converter using Ethernet with an Internet, wherein the Ethernet access point provides at least one of: a user access to Ethernet for user devices or an access point for casino related devices that are not slot machines.

A communication network for providing an Ethernet network and a first protocol to a plurality of gaming devices in a gaming area of a gaming establishment is disclosed herein. The communication network includes a server area Ethernet located in a server area of the gaming establishment; a gaming area Ethernet located in the gaming area of the gaming establishment; a long cable comprising a first twisted pair of wires and a second twisted pair of wires and a ground wire, having a first end located in the server area of the gaming establishment and a second end located in the gaming area of the gaming establishment; a first converter connected to the first end of the long cable and arranged to communicate with a second converter using a first protocol over the first twisted pair of wires, and connected to the server area Ethernet, and arranged to convert between the first protocol over the long cable and the server end Ethernet; the second converter connected to the second end of the long cable and arranged to communicate with the first converter using the first protocol over the first twisted pair of wires, and connected to the gaming area Ethernet, and arranged to convert between the first protocol over the long cable and the gaming area Ethernet; a fifth converter connected to the first end of the long cable and arranged to communicate with a sixth converter using a first protocol over the second twisted pair of wires, and connected to the server area Ethernet, and arranged to convert between the first protocol over the long cable and the server end Ethernet; the sixth converter connected to the second end of the long cable and arranged to communicate with the first converter using the first protocol over the second twisted pair of wires, and connected to the gaming area Ethernet, and arranged to convert between the first protocol over the long cable and the gaming area Ethernet; a controller board of a gaming device located in the gaming area, and arranged to communicate via the first and second converter using a second protocol with a game controller computer located in the server area Ethernet; and a game board of the gaming device located in the gaming area, and arranged to communicate via the fifth and sixth converter using Ethernet with a server.

The gaming devices may be slot machines.

The gaming establishment may be a casino.

The long cable may be a cable that is at least 1000 feet long.

The long cable may be longer than a rated communications distance between two Ethernet network devices.

The communication network may include an Ethernet access point located in the gaming area, and arranged to communicate via the fifth and sixth converter using Ethernet with an Internet, wherein the Ethernet access point provides at least one of: a user access to Ethernet for user devices or an access point for gaming establishment related devices that are not slot machines.

The second protocol may be RS-485 or Ethernet.

The communication network may include a third converter arranged to communicate with the controller board using the second protocol and to communicate with the gaming area Ethernet using Ethernet, and arranged to convert between the second protocol and Ethernet.

The communication network may include a fourth converter arranged to communicate with the game controller computer using the second protocol and to communicate with the server area Ethernet using Ethernet, and arranged to convert between the second protocol and Ethernet.

A method of converting a gaming establishment communication network with a long cable used for communication using RS-485, to a gaming establishment communication network with a server area Ethernet located in a server area of the gaming establishment, and a gaming area Ethernet located in the gaming area of the gaming establishment is disclosed. The method includes installing a first converter connected to the first end of the long cable, wherein the first converter is arranged to communicate with a second converter using a first protocol over the first twisted pair of wires, and connected to the server area Ethernet, and arranged to convert between the first protocol over the long cable and the server end Ethernet, wherein the long cable comprises at least a first twisted pair of wires and has a first end located in the server area of the gaming establishment and a second end located in the gaming area of the gaming establishment; installing the second converter connected to the second end of the long cable, wherein the second converter is arranged to communicate with the first converter using the first protocol over the first twisted pair of wires, and connected to the gaming area Ethernet, and arranged to convert between the first protocol over the long cable and the gaming area Ethernet, wherein a controller board of a gaming device is located in the gaming area, and arranged to communicate via the first and second converter using a second protocol with a game controller computer located in the server area Ethernet, and wherein a game board of the gaming device is located in the gaming area, and arranged to communicate via the first and second converter using Ethernet with a server.

The gaming devices may be slot machines.

The gaming establishment may be a casino.

The long cable may be a cable that is at least 1000 feet long.

The long cable may be longer than a rated communications distance between two Ethernet network devices.

The method of converting a casino communication may include installing an Ethernet access point located in the gaming area, wherein the Ethernet access point is arranged to communicate via the fifth and sixth converter using Ethernet with an Internet, and wherein the Ethernet access point provides at least one of: a user access to Ethernet for user devices or an access point for casino related devices that are not slot machines.

The second protocol is at least one of: RS-485 and Ethernet.

### BRIEF DESCRIPTION OF THE FIGURES

FIG. 1A is an illustration of a communication network in a casino;

FIG. 1B is an illustration of a casino floor with the existing communication network;

FIG. 2 is an illustration of an upgraded communication network utilizing the existing cabling according to a disclosed embodiment; and

FIG. 3 is an illustration of another embodiment of an upgraded communication network utilizing the existing cabling according to another disclosed embodiment.

### DETAILED DESCRIPTION OF THE DISCLOSED EMBODIMENTS

The figures and descriptions are simplified to illustrate elements that are relevant for a clear understanding of the disclosure, while eliminating, for the purpose of clarity, many other elements. Those having ordinary skill in the art may recognize that other elements and/or steps are desirable and/or required in implementing the disclosed embodiments. However, because such elements and steps are well known in the art, and because they do not facilitate a better understanding of the disclosure, a discussion of such elements and steps is not provided. The disclosure is directed to all such variations and modifications to such elements and methods known to those skilled in the art.

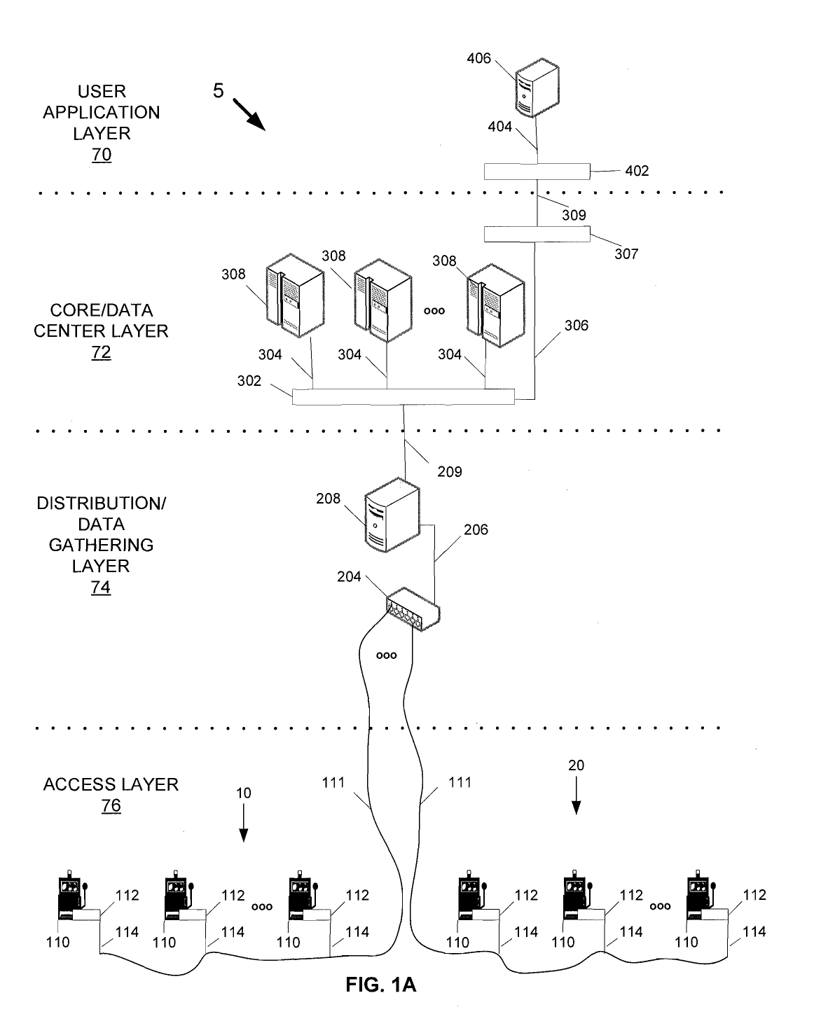

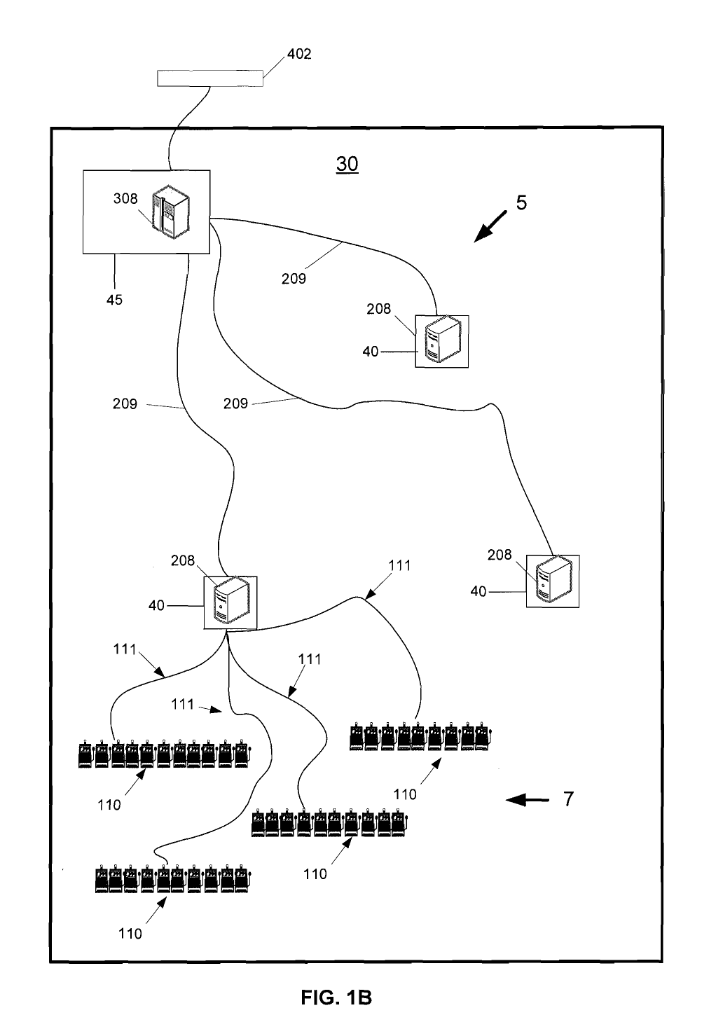

FIG. 1A is an illustration of a communication network 5 in a casino, and FIG. 1B is an illustration of a casino floor 30 with the communication network 5 of FIG. 1A. The communication network 5 provides a means for sending and receiving data to the slot machines 110. The communication network 5 includes four layers: a user application layer 70, a core/data center layer 72, a distribution/data gathering layer 74, and an access layer 76. The access layer 76 includes the slot machines 110 with controller boards 112. The controller boards 112 communicate with a game controller computer 208, which is part of the distribution/data gathering layer 74, using RS-485. Controller boards 112 may be referred to as GMUs. The controller boards 112 are connected by a wire 114 to a long cable 111 which runs from the gaming area 7 of the casino 30 to a server area 40 (see FIG. 1B) of the distribution/data gathering layer 74, which in this case may be a wiring closet, and eventually to the game controller computer 308 of the core/data center layer 72. There may be one to twenty or more slot machines 110 communicating over a single long cable 111, and a single game controller computer 208 may have approximately twenty-four long cables 111 attached. The slot machines 110 are often attached to the long cable 111 by a “t tap.” The long cable 111 may be from 1000 feet to more than 3000 feet. The long cable 111 may be longer than a rated communications distance between two Ethernet network devices. For example, the long cable may be longer than 300 feet for two Ethernet network devices that are rated to be within 300 feet of each other. The long cable 111 may be a cable with a first twisted pair of wires and a ground and may have a second twisted pair of wires. In some embodiments, the long cable 111 has more than two twisted pairs of wires. The long cable 111 may run up columns and down columns and in some cases may snake around a casino to finally arrive at a slot machine 110. Often, casinos were built without taking into consideration the wiring needs of slot machines 110 so that it may be very difficult to replace the long cable 111 or find another path between the slot machines 110 and the game controller computer 208 without modifying the casino 30 at considerable expense.

The next layer is the distribution/data gathering layer 74. The distribution/data gathering layer 74 includes a game controller computer 208, and may include an RS-232 to RS-485 converter 204. Parts of the distribution/data gathering layer 74 may be located in wiring closets 40 (see FIG. 1B). The game controller computer 208 sends and receives data to the slot machines 110 over the long cable 111. The game controller computer 208 may be connected to an RS-232 to RS-485 converter 204, which may have approximately 20 to 40 slots. The game controller computer 208 may send and receive data over the long cable 111 using RS-232 that is converted to RS-485 by the converter 204. The game controller computer 208 may communicate with 1 to 20 or more slot machines on each of the long cables 111 and may communicate with 1 to 40 or more long cables 111 so that the game controller computer 208 may communicate with anywhere from 20 to over 500 slot machines 110. A typical configuration may be for the game controller computer 208 to communicate with 24 long cables 111 each with 20 slot machines 110 for a total of 480 slot machines 110. RS-485 communications may use two twisted pairs of wires of the long cable 111.

The game controller computer 208 may poll each of the slot machines 110 for data regarding the use of the slot machines 110. For example, the game controller computer 208 may poll each slot machine 110 for the amount of money or tokens put in the slot machine 110 and the amount of money or tokens the slot machine 110 has paid out. The game controller computer 208 may store this data locally at the game controller computer 208. The game controller computer 208 may also send configuration information to the slot machines 110.

The game controller computer 208 communicates with a core/data center layer 72 over a cable 209. The game controller computer 208 may communicate with the core/data center layer 72 using Ethernet. The game controller computer 208 may send the data received from the slot machines 110 to a server 308. The game controller computer 208 may receive instructions from the server 308 for sending and receiving data and/or configuration information to the slot machines 112.

The core/data center layer 72 includes a gaming network 302, a gateway 307, and servers 308. The game controller computer 208 communicates with the servers 308 over the gaming network 302, and the servers 308 may communicate with the user application layer 70 via the gateway 307. The gaming network 302 may be Ethernet networking equipment. Examples of the gaming network 302 include a hub, concentrator, router, and switch. The gaming network 302 may communicate with the gateway 307 over communication link 306, which may be a wire. The gateway 307 may be a gateway to the user application layer 70. The gateway 307 may be router connected over communication link 309, which may be a wire, to network equipment 402, which may be network equipment that is part of the Internet or of an intranet. The servers 308 are computers that may be mainframes, mini-computer, microcomputers, or other types of computers capable of performing the functions of the servers 308. The servers 308 may be in communication with the gaming network 302 over communication link 304, which may be a cable. The servers 308 are in communication with one or more game controller computers 208, and receive the data received from the game controller computers 208 regarding slot machines 110. The servers 308 may be backed up in order to store the data regarding the slot machines 110. The servers 308 may include software that monitors the slot machines 110 and other conditions such as the number of guests in the casino and determine configuration information for the slot machines 110 based on the monitored conditions. The servers 308 may send and receive data and/or configuration information to the game controller computers 208. The computer architecture of having the game controller computers 208 handle the input/output of the slot machines 110 with the servers 308 receiving the data received from the slot machines 110 from the game controller computers 208 has several advantages. The servers 308 do not need to handle the input/output from the slot machines 110. The servers 308 can be backed-up with the game controller computers 208 keeping the data from the slot machines 110 for short periods of time. The servers 308 can also provide a larger platform for providing more sophisticated control of the slot machines 110 without having to deal with the low level input/output from the slot machines 110.

The next layer is the user application layer 70. The user application layer 70 may be in a computer room 45 of the casino 30 (see FIG. 1B.) The user application layer 70 includes a server 406, and network equipment 402. The servers 308 communicate with the server 406 via the gaming network 302 and the network equipment 402. The server 406 may be a computer that is part of the Internet or part of an intranet. The server 406 may have user applications for use by the slot machines 110, the game controller computers 208, and/or the servers 308. User applications for the slot machines 110 may run from the server 406 or may be downloaded to the slot machines 110, the game controller computers 208, and/or the servers 308. The game controller computers 208 may communicate directly with the server 406. The server 406 may be remotely located as for example a server 406 located somewhere on the Internet.

FIG. 1B illustrates the vast distance that the long cables 111 may traverse of the casino 30. Each of the long cables 111 may be 1000 to 3000 or more feet long and may not have been installed in cable passages, but rather in ad hoc fashion in the casino 30. The gaming area 7 may be vast with many thousands of slot machines 110 and spread out over many thousands of square feet.

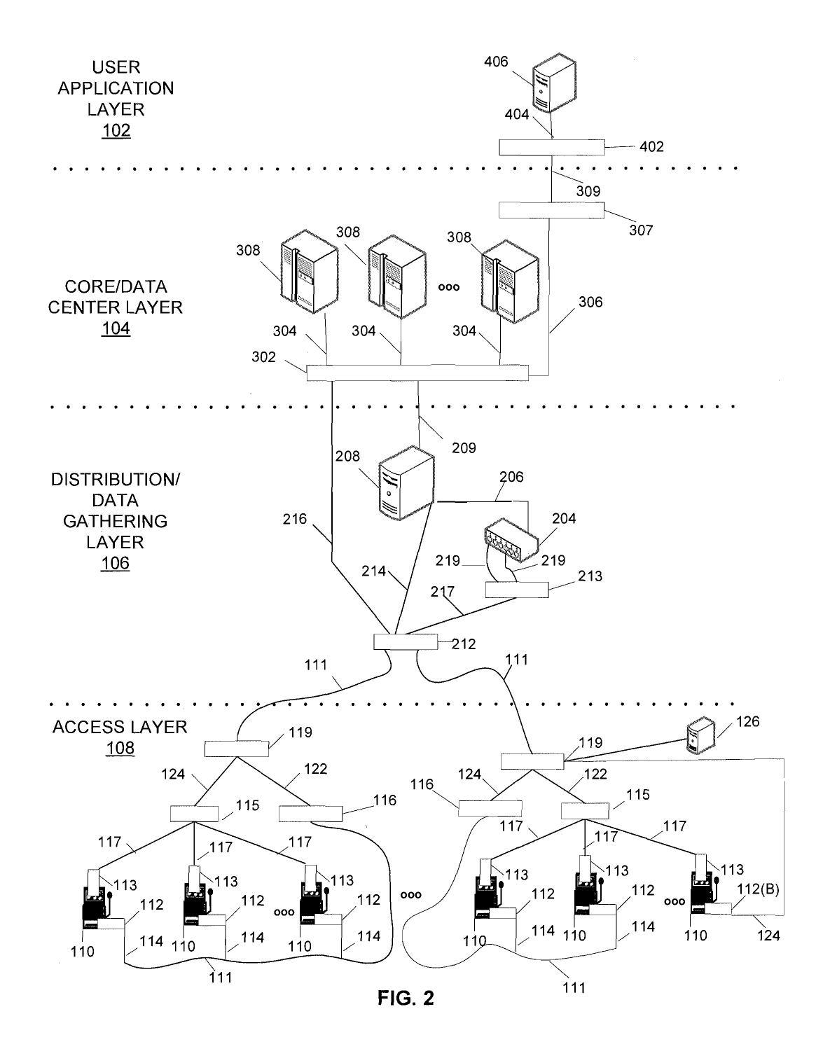

FIG. 2 is an illustration of an upgraded communication network utilizing the existing cabling according to an embodiment of the invention. The upgraded communication network has four layers: the user application layer 102, the core/data center layer 104, the distribution/data gathering layer 106, and the access layer 108.

Differences between the communication network of FIG. 1A and the communication network of FIG. 2 will be explained.

A first converter 212 is attached to a first end of the long cable 111, and a second converter 119 is connected to a second end of the long cable 111. The first converter 212 and the second converter 119 convert between an Ethernet protocol and a communications protocol that the first converter 212 and the second converter 119 use to communicate with one another over the long cable 111. The communications protocol may be, for example, digital subscriber line such as Zhone Bitstorm-HP™, VDSL2 IP™, or DSLAM™. The first converter 212 and the second converter 119 may be products such as a Slamnet™ 100 or 200. The first converter 212 and the second converter 119 may communicate over a first twisted pair of wires of the long cable 111, and may use a ground wire of the long cable 111. The first converter 212 may have one or more ports so that multiple second converters 119 may be attached to the first converter 212 via multiple long cables 111.

A third converter 116 is added to convert between the RS-485 communication protocol that is used by the controller boards 112 over communication link 114, which may be a cable, and Ethernet, which is used to communicate with the second converter 119 over communication link 122, which may be a cable. As illustrated in FIG. 2, controller boards 112(B) may communicate using Ethernet with the game controller computers 208 using communication link 124, which may be a cable, via the long cable 111.

A fourth converter 213 may be added to convert between RS-485, which is used to communicate with the converter 204 over communication link 219, which may be a cable, and Ethernet, which is used to communicate with the first converter 212 over communication link 217, which may be a cable.

This network architecture provides the advantage that the controller board 112 and the game controller computer 208 can continue to communicate using RS-485 as in FIG. 1A.

Game boards 113 may be added to the slot machines 110. The game boards 113 may be boards that provide additional functionality to the slot machine 110. For example, the game boards 113 may permit the players to play a video game. The game boards 113 may enable data relating to the user of the slot machine 110 and/or the casino 30 to be stored and recalled for single or multiple sessions of the user of the slot machine 110. For example, a level of play that the user has achieved may be stored and recalled between sessions of play. The game boards 113 may communicate directly with an Ethernet network device 115, which may be a switch, over communication link 117, which may be a cable. In embodiments, the game boards 113 may communicate directly with the second converter 119. The game boards 113 may communicate via the second converter 119 to the game controller computer 208, the servers 308, and/or the server 406.

An Ethernet access point may be provided in the gaming area 7 (FIG. 1B). For example, a computer 126 (see Access Layer 108, FIG. 2), may communicate via the second converter 119 to the game controller computer 208, the servers 308, and/or the server 406. The computer 126 may be, for example, a display at a bar that advertises the shows that are being presented at the casino 30. The computer 126 may communicate with servers 308, which may store data regarding the available of the shows and discounts to the shows. The computer 126 may permit a guest to purchase or receive for free a ticket to a show. In some embodiments, the computer 126 may be a computer 126 of guest of the casino and there may be many computers 126 communicating via the second converter 119.

The second converter 119 may provide separate Ethernets for the computer 126, the controller board 112, and the game boards 113. Separate Ethernets may be required by government gaming boards for security purposes. Additionally, the casinos may want separate Ethernet for security purposes.

Communication link 216 may be provided so that the game boards 113, the computer 126, and/or the controller boards 112, can communicate with the servers 308 and/or the Internet, for example server 406, without going through the game controller computer 208.

The game controller computer 208 may include a communication link 214 to the first converter 212 so that game controller computer 208 can communicate with the computer 126, the controller boards 112(B), and/or the game boards 113 directly without using the protocol used on communication link 206.

The communication links and/or the wiring may be category 4/5 wiring or any type of wiring that is suitable for connecting the various electronic devices. Any of the communication links may be wireless links. For example, second converter 119 may provide a wireless functionality and the game boards 113 may communicate directly with the second converter 119 over a wireless connection such as 802.11b/g/n.

Thus, the upgraded communication network illustrated in FIG. 2 provides the following advantages while using the long cable 111, and avoiding having to install new cabling between the access layer 76 and the distribution/data gather layer 74. The upgraded communication network has the advantage that game boards 113 can communicate using an Ethernet via the long cable 111. The upgraded communication network has the additional advantage that an Ethernet access point located in the gaming area 7 and access layer 108, for example computer 126, is provided via the long cable 111. The upgraded communication network has the additional advantage that the communication speed to the controller boards 112 may be faster, and the communication speed to the access layer 108 is faster. The upgraded communication network may have the advantage of providing communication using Ethernet between the controller boards 112(B) and the game controller computers 208. As discussed, the second converter 119 may keep the communication between the controller boards 112 and other devices separate to provide security for the communication to and from the controller boards 112.

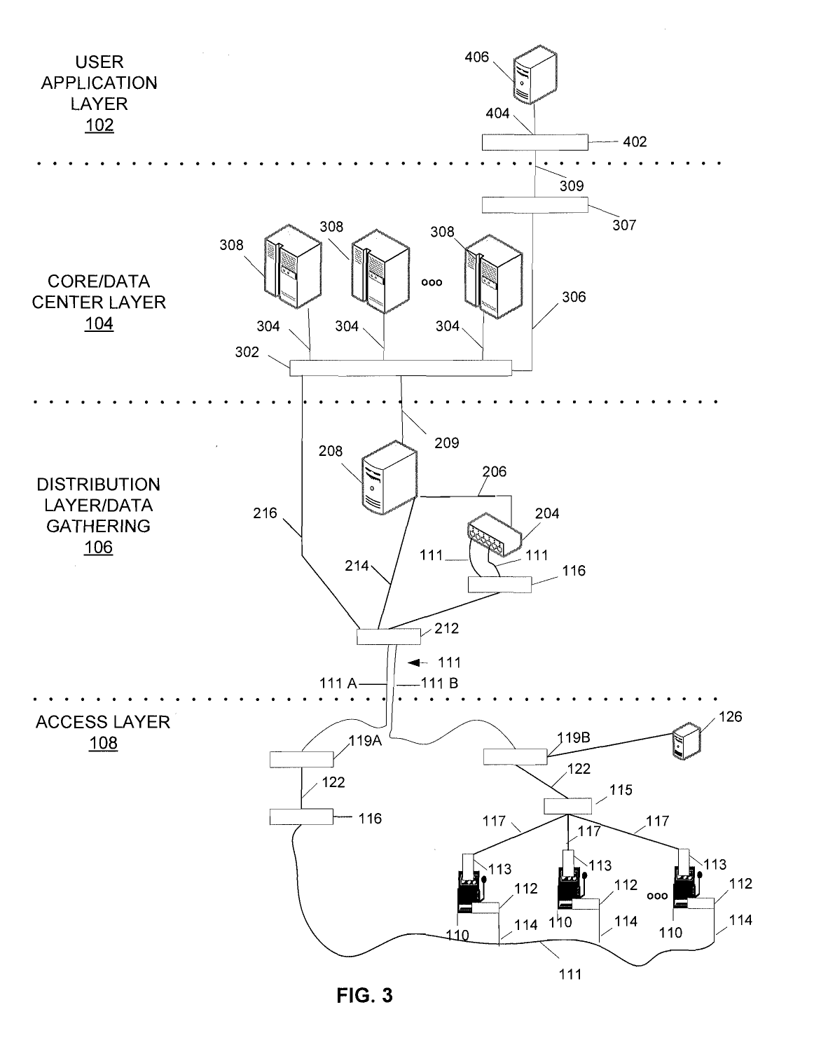

FIG. 3 is an illustration of an upgraded communication network utilizing the existing cabling according to another embodiment of the invention. The upgraded communication network illustrated in FIG. 3 has four layers: the user application layer 102, the core/data center layer 104, the distribution/data gathering layer 106, and the access layer 108.

Some differences between the communication network of FIG. 2 and the communication network of FIG. 3 will be explained. In FIG. 3, the long cable 111 of FIGS. 1A, 1B, and 2, is being used to provide two Ethernets to the access layer 108. Long cable 111A uses a first twisted pair of wires of long cable 111, and long cable 111B uses a second twisted pair of wires of long cable 111. There are two second converters 119A, and 119B, which communicate with the first converter 212. The first converter 212 and both the second converter 119A and the second converter 119B convert between an Ethernet and a communications protocol that the first converter 212 and the two second converters 119A, 119B use to communicate with one another over the long cable 111.

The controller boards 112 communicate via the second converter 119A. The games boards 113 communicate via the second converter 119B. And an Ethernet access point communicates via the second converter 119B. For example, as illustrated in FIG. 3, computer 126 communicates via second converter 119B. In this way, secure communications is provided for the controller 112 boards.

In embodiments, the game boards 113 may communicate via the second converter 119A. In embodiments, the computer 126 (Ethernet access point), the game boards 113, and the controller board 112, may communicate over either one or both of the second converters 119A, 119B. The second converters 119A, 119B may be configured to provide redundancy in case one of the Ethernets provided by second converters 119A, 119B malfunctions.

Thus, the upgraded communication network utilizing the existing cabling illustrated in FIG. 3 provides the additional advantage that the long cable 111 may be utilized to provide a second connection between the access layer 108 and another layer of the network, and/or may be used to provide secure communications between the controller boards 112 and the game boards 113 and/or the computer 126 (Ethernet access point).

Although the disclosed embodiments have been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the claims as set forth hereinafter. The disclosed system and method are applicable to communication networks in general and are not limited to casino communications networks or other special purpose networks.

What is claimed is:

1. A communication network for providing an Ethernet network and a first protocol to a plurality of gaming devices in a gaming area of a gaming establishment, the network comprising:
a server area Ethernet network located in a server area of the gaming establishment;
a gaming area Ethernet network located in the gaming area of the gaming establishment;
a long cable comprising at least a first twisted pair of wires and having a first end located in the server area of the gaming establishment and a second end located in the gaming area of the gaming establishment;
a first converter connected to the first end of the long cable and arranged to communicate with a second converter using a first protocol over the first twisted pair of wires, and connected to the server area Ethernet network, and arranged to convert between the first protocol over the long cable and the server end Ethernet network;
the second converter connected to the second end of the long cable and arranged to communicate with the first converter using the first protocol over the first twisted pair of wires, and connected to the gaming area Ethernet network, and arranged to convert between the first protocol over the long cable and the gaming area Ethernet network;
a controller board of a gaming device located in the gaming area, and arranged to communicate via the first and second converter using a second protocol with a game controller computer located in the server area Ethernet network; and
a game board of the gaming device located in the gaming area, and arranged to communicate via the first and second converter using Ethernet with a server.

2. The communications network of claim 1, wherein the gaming devices are slot machines.

3. The communications network of claim 1, wherein the gaming establishment is a casino.

4. The communications network of claim 1, wherein the long cable is at least 1000 feet long.

5. The communications network of claim 1, wherein the long cable is longer than a rated communications distance between two Ethernet network devices.

6. The communication network of claim 1, further comprising:
a third converter arranged to communicate with the controller board using the second protocol and to communicate with the gaming area Ethernet network using Ethernet, and arranged to convert between the second protocol and Ethernet.

7. The communication network of claim 6, further comprising:
an Ethernet device arranged between the second converter and the gaming area Ethernet network, wherein the controller board communicates with the game controller computer via the Ethernet device, and wherein the game board communicates with the server via the Ethernet device.

8. The communication network of claim 7, wherein the Ethernet device is arranged so that the game board does not receive Ethernet packets sent by the controller board.

9. The communication network of claim 7, wherein the Ethernet device is an Ethernet switch.

10. The communication network of claim 1, further comprising:
an Ethernet access point located in the gaming area, and arranged to communicate via the first and second converter using Ethernet with a server located in the server area Ethernet network, wherein the Ethernet access point provides at least one of: a user access to Ethernet for user devices or an access point for gaming establishment related devices that are not gaming devices.

11. The communication network of claim 1, further comprising:
a fourth converter arranged to communicate with the game controller computer using the second protocol and to communicate with the server area Ethernet network using Ethernet, and arranged to convert between the second protocol and Ethernet.

12. The communication network of claim 1, wherein the game board is arranged to communicate via the first and second converter using Ethernet with an Internet.

13. The communication network of claim 1, wherein the second protocol is at least one of: RS-485 and Ethernet.

14. The communication network of claim 1, wherein the first protocol is a digital subscriber line.

15. The communication network of claim 1, wherein the long cable further comprises a second twisted pair of wires, and a fifth and sixth converter communicate over the second twisted pair of wires, and further comprising:
an Ethernet access point located in the gaming area, and arranged to communicate via the fifth and sixth converter using Ethernet with an Internet, wherein the Ethernet access point provides at least one of: a user access to Ethernet for user devices or an access point for gaming establishment related devices that are not gaming devices.

16. A communication network for providing an Ethernet network and a first protocol to a plurality of gaming devices in a gaming area of a gaming establishment, the network comprising:
a server area Ethernet network located in a server area of the gaming establishment;
a gaming area Ethernet network located in the gaming area of the gaming establishment;
a long cable comprising a first twisted pair of wires and a second twisted pair of wires and a ground wire, having a first end located in the server area of the gaming establishment and a second end located in the gaming area of the gaming establishment;
a first converter connected to the first end of the long cable and arranged to communicate with a second converter using a first protocol over the first twisted pair of wires, and connected to the server area Ethernet network, and arranged to convert between the first protocol over the long cable and the server end Ethernet network;
the second converter connected to the second end of the long cable and arranged to communicate with the first converter using the first protocol over the first twisted pair of wires, and connected to the gaming area Ethernet network, and arranged to convert between the first protocol over the long cable and the gaming area Ethernet network;
a fifth converter connected to the first end of the long cable and arranged to communicate with a sixth converter using a first protocol over the second twisted pair of wires, and connected to the server area Ethernet network, and arranged to convert between the first protocol over the long cable and the server end Ethernet network;
the sixth converter connected to the second end of the long cable and arranged to communicate with the first converter using the first protocol over the second twisted pair of wires, and connected to the gaming area Ethernet network, and arranged to convert between the first protocol over the long cable and the gaming area Ethernet network;
a controller board of a slot machine located in the gaming area, and arranged to communicate via the first and second converter using a second protocol with a game Controller computer located in the server area Ethernet network; and
a game board of the slot machine located in the gaming area, and arranged to communicate via the fifth and sixth converter using Ethernet with a server.

17. The communication network of claim 16, further comprising:
an Ethernet access point located in the gaming area, and arranged to communicate via the fifth and sixth converter using Ethernet with an Internet, wherein the Ethernet access point provides at least one of: a user access to Ethernet for user devices or an access point for casino related devices that are not slot machines.

18. The communication network of claim 16, wherein the second protocol is at least one of: RS-485 and Ethernet.

19. The communication network of claim 16, further comprising:
a third converter arranged to communicate with the controller board using the second protocol and to communicate with the gaming area Ethernet network using Ethernet, and arranged to convert between the second protocol and Ethernet.

20. The communication network of claim 16, further comprising:
a fourth converter arranged to communicate with the game controller computer using the second protocol and to communicate with the server area Ethernet network using Ethernet, and arranged to convert between the second protocol and Ethernet.

21. A method of converting a gaming establishment communication network with a long cable used for communication using RS-485, to a gaming establishment communication network with a server area Ethernet network located in a server area of the gaming establishment, and a gaming area Ethernet network located in the gaming area of the gaming establishment;
installing a first converter connected to the first end of the long cable, wherein the first converter is arranged to communicate with a second converter using a first protocol over the first twisted pair of wires, and connected to the server area Ethernet network, and arranged to convert between the first protocol over the long cable and the server end Ethernet network, wherein the long cable comprises at least a first twisted pair of wires and has a first end located in the server area of the gaming establishment and a second end located in the gaming area of the gaming establishment;
installing the second converter connected to the second end of the long cable, wherein the second converter is arranged to communicate with the first converter using the first protocol over the first twisted pair of wires, and connected to the gaming area Ethernet network, and arranged to convert between the first protocol over the long cable and the gaming area Ethernet network,
wherein a controller board of a gaming device is located in the gaming area, and arranged to communicate via the first and second converter using a second protocol with a game controller computer located in the server area Ethernet network, and
wherein a game board of the gaming device is located in the gaming area, and arranged to communicate via the first and second converter using Ethernet with a server.

22. The method of converting a gaming establishment communication network of claim 21, further comprising:
installing an Ethernet access point located in the gaming area, wherein the Ethernet access point is arranged to communicate via the fifth and sixth converter using Ethernet with an Internet, and wherein the Ethernet access point provides at least one of: a user access to Ethernet for user devices or an access point for casino related devices that are not gaming devices.

23. The method of converting a gaming establishment communication network of claim 21, wherein the second protocol is at least one of: RS-485 and Ethernet.
